(19) United States
(12) Patent Application Publication
(10) Pub. No.: US 2002/0070537 A1
(43) Pub. Date: Jun. 13, 2002

(54) Tensioning device for side restraint

(76) Inventors: James Lloyd Webber, Shelby Township, MI (US); Jeffrey Allen Welch, Washington, MI (US); Gregg G. Anderson, St Clair Shores, MI (US); Douglas Stephen Weston, Tipp City, OH (US)

Correspondence Address: KATHRYN A. MARRA, DELPHI TECHNOLOGIES, INC., Legal Staff, Mail Code: 480-414-420, P.O. Box 5052, Troy, MI, 48007-5052, US

(21) Appl. No.: 09/992,342

(22) Filed: Nov. 19, 2001

Related U.S. Application Data
(60) Provisional application No. 60/252,844, filed on Nov. 22, 2000.

(51) Int. Cl. B60R 21/22

(52) U.S. Cl. 280/730.2; 280/743.2

(57) ABSTRACT

A tensioning system which provides continuous tensioning to an inflatable curtain air bag during deployment of the curtain air bag. A dynamic tethering element is utilized which travels in conjunction with the downward deployment of the inflatable curtain air bag so as to both tension the curtain air bag while at the same time providing a guiding action so as to bring the curtain air bag into the proper position at which it is thereafter maintained.

### CROSS-REFERENCE TO RELATED APPLICATIONS

This application claims priority from U.S. Provisional application 60/252,844 filed Nov. 22, 2000, the contents of which are incorporated by reference herein.

### TECHNICAL FIELD

The present invention relates to an assembly for tensioning an inflatable curtain-type restraint across a side portion of a vehicle during a collision event.

### BACKGROUND OF THE INVENTION

It is well known in motor vehicles to provide air bag cushions for protecting a vehicle occupant during a collision event wherein such air bag cushions are in fluid communication with gas generating inflators so as to inflate the cushions upon sensing predetermined vehicle conditions such as deceleration exceeding a certain level. It is further known to provide air bag systems including inflatable restraint cushions which are deployed from positions of attachment along the roof rail portion of the vehicle frame above the doors of the vehicle such that the inflatable cushion extends downwardly in substantially curtain-like fashion between the occupant to be protected and the side portions of the vehicle adjacent to such occupants. Such coverage provides a cushioning restraint to the occupant during a side impact or extended roll-over collision event thereby aiding in the protection of the occupant during such events.

It is generally desirable for a curtain-like side air bag cushion to be held in a substantially tensioned condition across the surface being covered so as to provide a well defined extended barrier between the occupant and the side portion of the vehicle. Such a condition may be useful in holding the vehicle occupant within the protective frame of the vehicle during an extended roll-over event.

A typical prior tethering arrangement for maintaining tension across the lower edge of a curtain-like cushion is illustrated in FIGS. 1A and 1B. As illustrated, in such prior embodiments an inflatable curtain 10 is stored in packed relation generally along the roof rail 12 of a vehicle 14 generally above the doors 16. The length of the inflatable curtain 10 is such that upon inflation coverage is provided over at least a portion of the distance extending along the side of the vehicle interior between two or more structural pillars 20 extending away from the roof rail 12.

In the illustrated embodiment, the inflatable curtain 10 is shown to be attached at the forward “A” pillar and at the rearward “C” pillar so as to cover the intermediate “B” pillar. As shown, in prior constructions the inflatable curtain 10 is inflated by a gas generating inflator 22 thereby causing the lower edge of the inflatable curtain 10 to move downwardly away from the roof rail 12. As the inflatable curtain 10 undergoes inflation, it tends to shorten as cushioning depth is developed (FIG. 1B). This shortening may be restricted by the presence of tethering straps 24 of fixed length extending between the lower edge of the inflatable curtain 10 and the forward and rearward pillars 20 bordering the area to be covered.

Utilizing the prior design of fixed length tethers 24 is useful in providing tension across the lower edge once the designed inflation of the inflatable curtain 10 is complete. In particular, once the curtain is in the fully inflated condition, a balanced tension is established and may thereafter be maintained between the shortened inflatable curtain 10 and the fully extended tethering straps 24. Thus prior curtain constructions which utilize a combination of inflation induced shortening and fixed length tethering straps 24 are typically dependent upon the cushion shape being substantially fully established before the final tension is generated. Accordingly, tensioning may be absent during the preliminary stages of deployment prior to the bottom edge becoming positioned and fully tensioned.

### SUMMARY OF THE INVENTION

This invention provides advantages and alternatives over the prior art by providing a tensioning system which provides continuous tensioning to an inflatable curtain structure during inflation and which is not dependent upon the achievement of any particular deployed position to provide tensioning support to the cushion.

In the invention, a dynamic tethering element is utilized which travels in conjunction with the downward deployment of the inflatable curtain structure so as to both tension the curtain structure while at the same time providing a guiding action so as to bring the curtain structure into the proper position at which it is thereafter maintained. The dynamic tethering element avoids total reliance upon curtain shortening to provides a tensioning force across the inflatable curtain structure. In addition, the dynamic tethering element may be useful in pulling the inflating curtain into a desired position at an early stage of deployment. Accordingly, a number of new and useful advantages are provided over the prior art.

### BRIEF DESCRIPTION OF THE DRAWINGS

The accompanying drawings which are incorporated in and which constitute a part of this specification illustrate several potentially preferred embodiments of the present invention and, together with a general description of the invention given above and the detail description set forth below, serve to explain the principles of the invention wherein:

FIGS. 1A and 1B are cut-away side views of a vehicle incorporating a prior-art tethering system;

FIG. 2A is a cut-away view of a dynamic tensioning device for moving a tethering strap in conjunction with the deployment of an inflatable curtain;

FIG. 2B is a cut-away view of a vehicle side interior incorporating the assembly of FIG. 2A following deployment of a tensioned air bag curtain;

FIG. 3A illustrates a dynamic tensioning device for use in the controlled movement of a tensioning strap in conjunction with deployment of an associated inflatable curtain;

FIG. 3B is a cut-away view of a vehicle side interior incorporating the assembly of FIG. 3A following deployment of a tensioned air bag curtain;

FIG. 4A illustrates a dynamic tensioning device for use in the controlled movement of a tensioning strap in conjunction with deployment of an associated inflatable curtain;

FIG. 4B is a cut-away view of a vehicle side interior incorporating the assembly of FIG. 4A following deployment of a tensioned air bag curtain;

FIG. 5A is a cut-away view of a tensioning device for use in both moving the tether in conjunction with the deployment of an inflatable curtain structure and in simultaneously adjusting the length of the tether such that tension is continuously maintained;

FIG. 5B is a side view of a vehicle interior illustrating an inflatable curtain deployed in conjunction with the tensioning assembly illustrated in FIG. 5A;

FIG. 5C is a view taken along line 5C-5C of a spring biased locking pin assembly for use in conjunction with the tensioning assembly of FIG. 5A;

FIG. 6A is an exploded assembly view of a tether tensioning device utilizing a stroking piston movement;

FIG. 6B is an assembled view of the tether tensioning device of FIG. 6A including an adjustable tethering strap;

FIG. 7 is a plan view of a locking element for use in maintaining the tensioned condition of the tethering element following deployment of the inflatable curtain;

FIG. 8 is a cut-away view of an extended side portion of a vehicle interior illustrating a first placement position for the tensioning device illustrated in FIGS. 6A and 6B wherein tensioning and cushion inflation are driven by a common gas-generating device;

FIG. 9 is a view similar to FIG. 8 showing an alternative placement location for the tensioning device;

FIG. 10 is a view taken generally along line 10-10 in FIG. 9 illustrating a gas conveyance path for use in directing inflation gas from a common inflator to an inflatable curtain and to the tensioning device;

FIG. 11 is a cut-away view of a self actuating tether tensioning assembly;

FIG. 12 illustrates operation of a tether tensioning assembly as illustrated in FIG. 11; and

FIG. 13 illustrates a tensioning arrangement for use in tensioning the sides of an air bag curtain of split construction so as to provide accommodation for passage around a seat belt web.

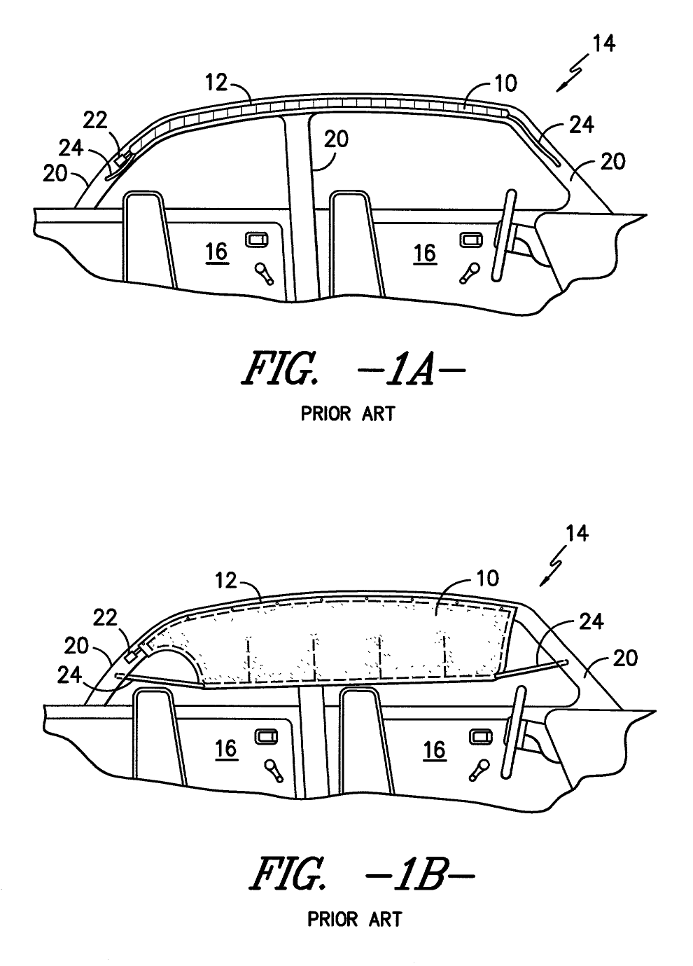

While the invention has been illustrated and generally described above and will hereinafter be described in connection with certain potentially preferred embodiments and procedures, it is to be understood and appreciated that in no event is the invention to be limited to such illustrated and described embodiments and procedures. On the contrary, it is intended that the present invention shall extend to all alternatives and modifications as may embrace the broad principles of this invention within the true spirit and scope thereof.

### DESCRIPTION OF THE PREFERRED EMBODIMENT

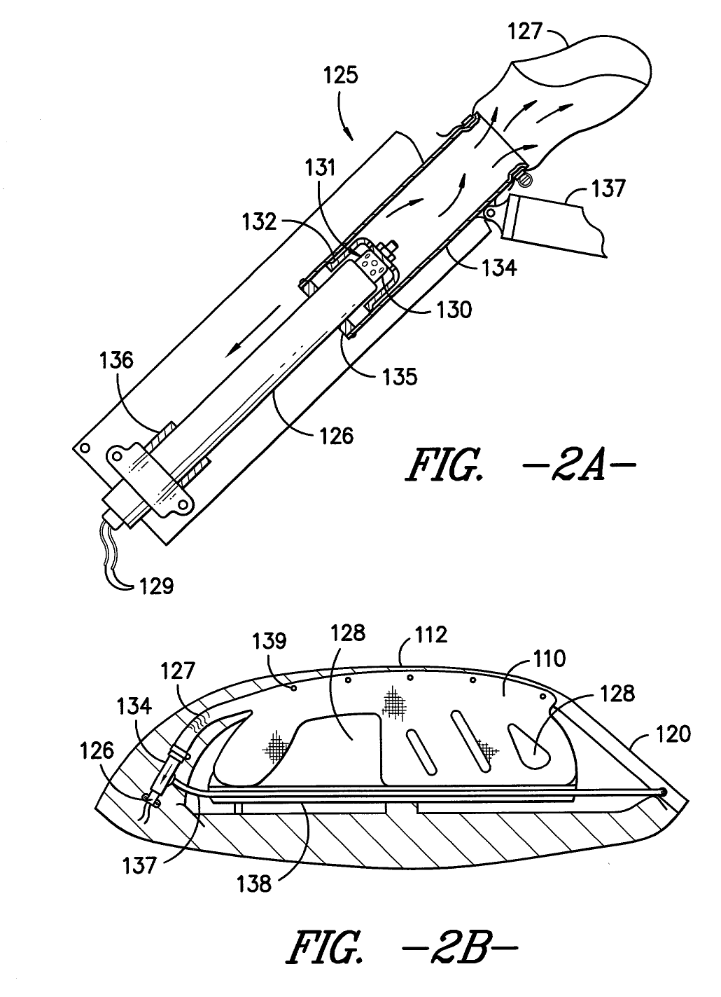

In FIGS. 2A and 2B, a first illustrative embodiment is illustrated. In FIG. 2A, there is illustrated a first tether tensioning device 125. As shown, in this embodiment a gas generating inflator 126 is disposed in fluid communication with the neck 127 of an inflatable curtain 110 (FIG. 2B) which is normally disposed in folded condition along the roof rail 112 of the vehicle prior to deployment. As shown, it is contemplated that the inflatable curtain 110 may include noninflating regions 128 at pre-established locations across the inflatable curtain 110. Of course, the presence of such non-inflating regions 128 is fully discretionary.

As will be appreciated, upon the receipt of an activating signal through leads 129 the inflator 126 emits a pressurized volume of inflation gas through gas emitting openings arranged at a discharge end 131 of the inflator 126. A directional cap element 132 may be held in place over the discharged end 131 so as to convey the emitted discharge gas in a desired direction. By way of example only, and not limitation, one such arrangement of inflator and directional cap element is illustrated and described in U.S. Pat. No. 5,803,486 to Spencer et al, the contents of which are incorporated by reference in their entirety as if fully set forth herein.

As shown, a sliding cylinder 134 extends between the inflator 126 and the neck 127 of the inflatable curtain 110 so as to define a gas transmission conduit between the inflator 126 and the inflatable curtain 110. As shown, the sliding cylinder 134 is carried on a bearing seal 135 so as to permit movement of the sliding cylinder 134 along the body of the inflator 126 without substantial gas leakage. Sufficient material is present within the neck portion 127 of the inflatable curtain to permit such movement. A bumper guard 136 of hard rubber or like material limits the axial movement of the sliding cylinder 134 as it moves downwardly along the inflator 126.

In the illustrated embodiment, the sliding cylinder 134 is attached to a tensioning tether element 137 which extends to the inflatable curtain 110. It is contemplated that the tensioning tether element 137 may be attached at a lower edge of the inflatable curtain 11O or may extend through a sleeve 138 or other carrying structure for attachment to an opposing structural pillar 120 in the manner as illustrated in FIG. 2B. It is also contemplated that any number of other attachment arrangements between the tensioning tether element 137 and the inflatable curtain 110 as may be known to those of skill in the art may likewise be utilized if desired.

Regardless of the attachment arrangement which is utilized between the tensioning tether element 137 and the inflatable curtain 110, the operation of the tether tensioning device 125 is the same. In operation, upon the discharge of inflation gas from the gas emitting openings 130, the inflation gas is transmitted through the sliding cylinder 134 and into the neck portion 127 of the inflatable curtain 110. Upon the introduction of the inflation gas, the inflatable curtain 110 expands downwardly and away from the roof rail 112. During this expansion, the upper edge of the inflatable curtain 110 is held in place along the roof rail 112 at connection points 139 in the manner as will be well known to those of skill in the art.

As the lower edge of the inflatable curtain 110 moves downwardly away from roof rail 112, a downward force is likewise applied to the tensioning tether element 137. The application of this downward force pulls the tensioning tether element 137 and the attached sliding cylinder 134 in a downward direction moving along the length of the inflator 126 until contacting the bumper guard 136. The sliding cylinder 134 and attached tensioning tether element 137 are thereby moved from the position illustrated in FIG. 2A to the orientation illustrated in FIG. 2B.

Simultaneous with the downward movement of the inflatable curtain 110 and the accompanying vertical force component applied to the tensioning tether element 137, the inflatable curtain 110 also undergoes a degree of shortening as inflation takes place. This shortening gives rise to the application of a substantially horizontal force component to the tensioning tether element 137. It is believed that the ability of the tensioning tether element 137 to move downwardly in conjunction with the inflatable curtain 110 as both vertical and horizontal tensioning forces are applied permits the tensioning tether element 137 to be maintained in a state of tensioned dynamic equilibrium during the inflation event while nonetheless using a tether which is of substantially fixed length.

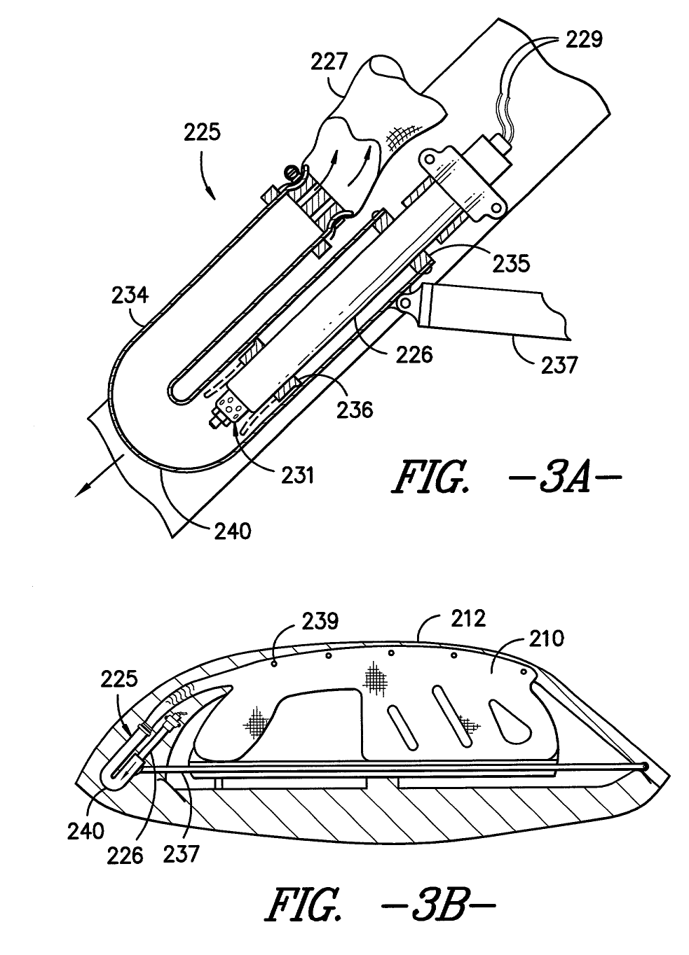

In FIGS. 3A and 3B, there is illustrated a variant to the assembly illustrated and described in relation to FIGS. 2A and 2B. In FIGS. 3A and 3B, elements corresponding to those previously illustrated and described are designated by like reference numerals increased by 200. As best seen by simultaneous reference to FIGS. 3A and 3B, in this embodiment the tether tensioning device 225 is arranged such that the inflator 226 projects downwardly at an angle extending away from the inflation path of the inflatable curtain 210. In this embodiment, inflation gas is projected outwardly from the discharge end 231 of the inflator 226 and into contact with a reverse bend 240 within the sliding cylinder 234 extending between the inflator 226 and the neck portion 227 of the inflatable curtain.

In operation, upon the application of pressure at the interior of the reverse bend 240, the U-shaped sliding cylinder 234 is biased in a downward direction and may slide over the inflator 226 along bearing seals 235 to the extent permitted by the tensioning tether element 237. The distance of possible movement by the U-shaped sliding cylinder 234 is limited by a bumper guard 236 held at a predetermined position along the length of the inflator. During an inflation event, the discharge of inflation gas initially pushes against the reverse bend 240 thereby establishing an initial tension within the tensioning tether element 237 as the U-shaped sliding cylinder attempts to move downwardly in response to the applied force. This downward movement is permitted only as the inflatable curtain 210 moves downwardly. Thus, a state of tensioned dynamic equilibrium is established across the tensioning tether element 237 from initial activation of the inflator 226 until deployment of the inflatable curtain 210 is completed.

As will be appreciated, the introduction of tension within the tensioning tether element 137, 237 in the tensioning assemblies illustrated in FIGS. 2A and 3A is in each case augmented by the fact that the tensioning tether element is moved along a path extending downwardly and angled away from the air bag curtain. The movement of the tensioning tether elements in such an angled path results in the introduction of both horizontal and vertical force components. As the tensioning tether element 137, 237 is moved along the path, the horizontal force component within the tether element is increased thereby requiring an increasing vertical force component to effect continued movement thereby establishing a continuing state of dynamic tension during the entire process.

It is contemplated that in both of the embodiments illustrated in FIGS. 2A and 3A, the tensioning tether element 137, 237 may undergo an initial rapid downward movement as pressure is expelled from the inflator and any available slack in the tensioning tether elements is taken up. In some instances, it may be beneficial to dampen the initial pressure surge by locating the inflator at a location remote from the tensioning tether elements 137, 237. In such arrangements it is contemplated that a extension conduit such as a dimensionally stable straight or angled metal tubing structure may extend away from the inflator in which case the sliding cylinder 134, 234 may slide along the extension conduit rather than along the inflator.

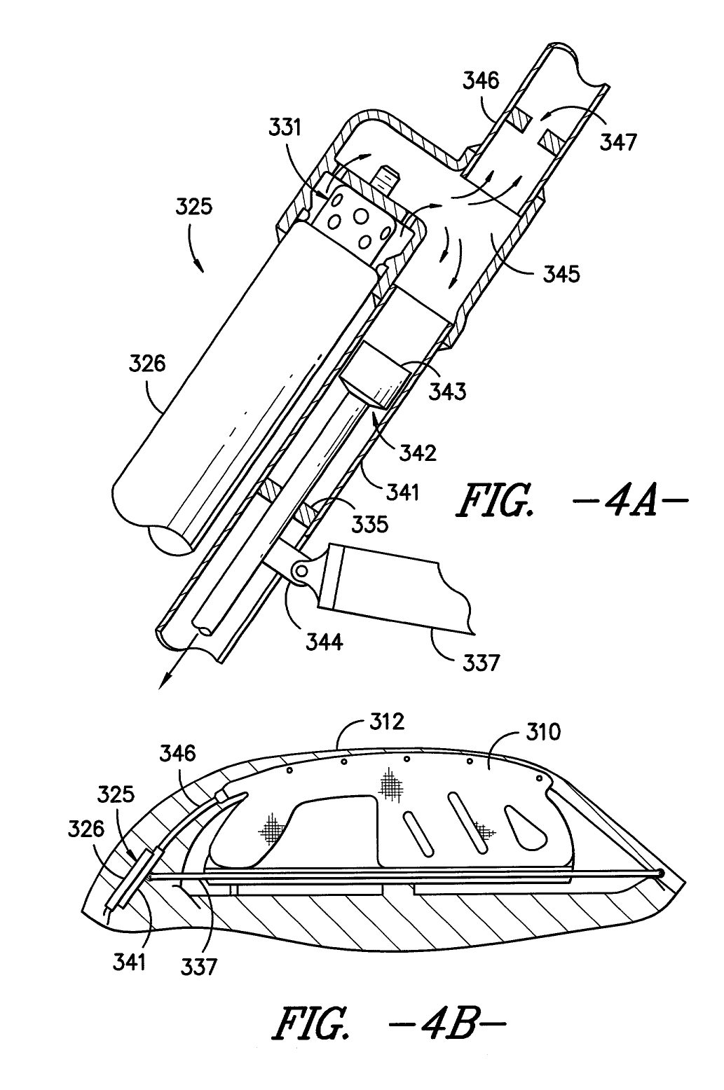

In FIGS. 4A and 4B, there is illustrated another embodiment for a tether tensioning device 325 which may find applicability at a remote storage location away from the inflatable curtain 310. In FIGS. 4A and 4B, elements corresponding to structures previously described are designated by corresponding reference numerals increased by 300. As shown, in the tether tensioning assembly 325 of FIG. 4A and inflator 326 is mounted in substantially parallel relation to a gas accepting cylinder 341. A piston element 342 is carried in sliding relation within the gas accepting cylinder 341. The piston element 342 includes a head portion 343 having dimensions substantially mated to the interior of the gas accepting chamber so as to establish a substantially gas tight sliding relation. An attachment arm 344 projects away from the piston element 342 through a slot within the gas accepting chamber 341 and is adjoined to a tensioning tether element 337 as previously described. As will be appreciated, in such an arrangement gas pressure is maintained by the bearing seal 335 located below the head portion 343.

The inflator 326 expels inflation gas into a dual outlet chamber 345 so as to convey a portion of the inflation gas into the gas accepting cylinder 341 as well as into a transmission conduit 346 extending to the inflatable curtain 310 (FIG. 4B). As illustrated, the transmission conduit 346 may include a flow restricting orifice 347 so as to aid in the establishment of a pressure within the dual outlet chamber 345.

In operation, upon the discharge of inflation gas into the dual outlet chamber 345, a driving force is established across the head portion 343 of the piston element 342 thereby biasing the piston element 342 to move downwardly through the gas accepting cylinder 341 in angled relation away from the inflatable curtain 310. However, due to the attachment between the tensioning tether element 337 and the inflatable curtain 310 movement of the piston element 342 is permitted only as relaxation is introduced into the tensioning tether element 337 as the inflatable curtain 310 moves downwardly. Thus, as the inflatable curtain 310 moves away from the roof rail 312 a system of dynamic tension is established and maintained across the tensioning tether element 337 such that the tensioning tether element 337 is in a state of substantially continuous tension during the deployment event.

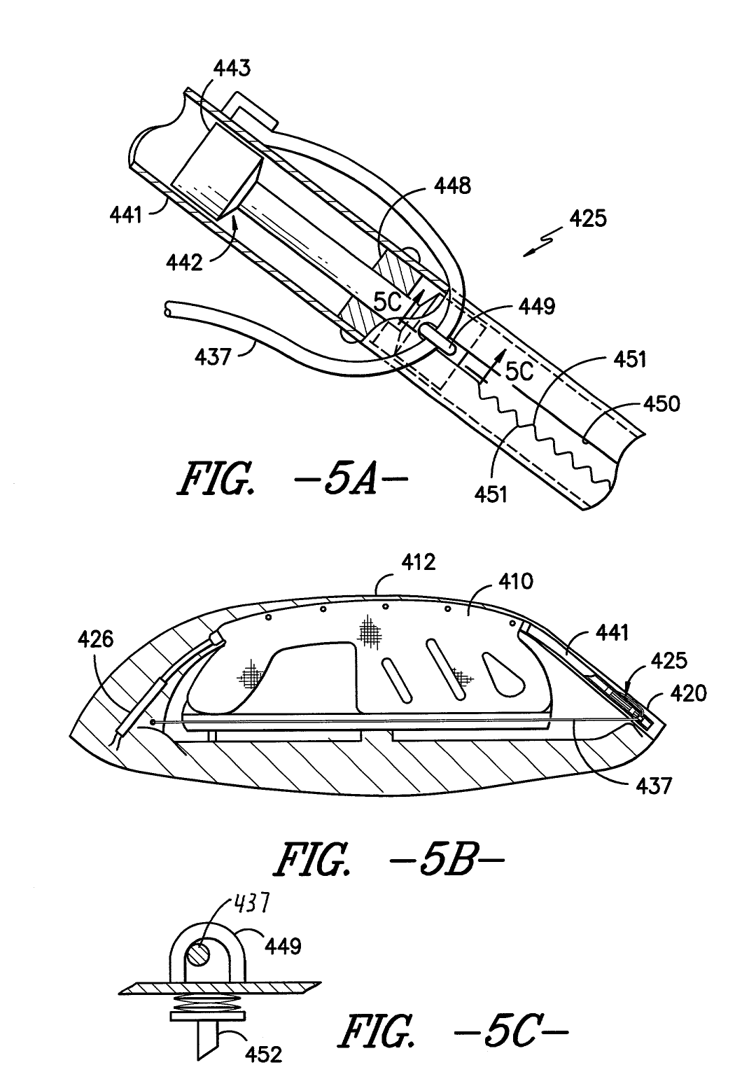

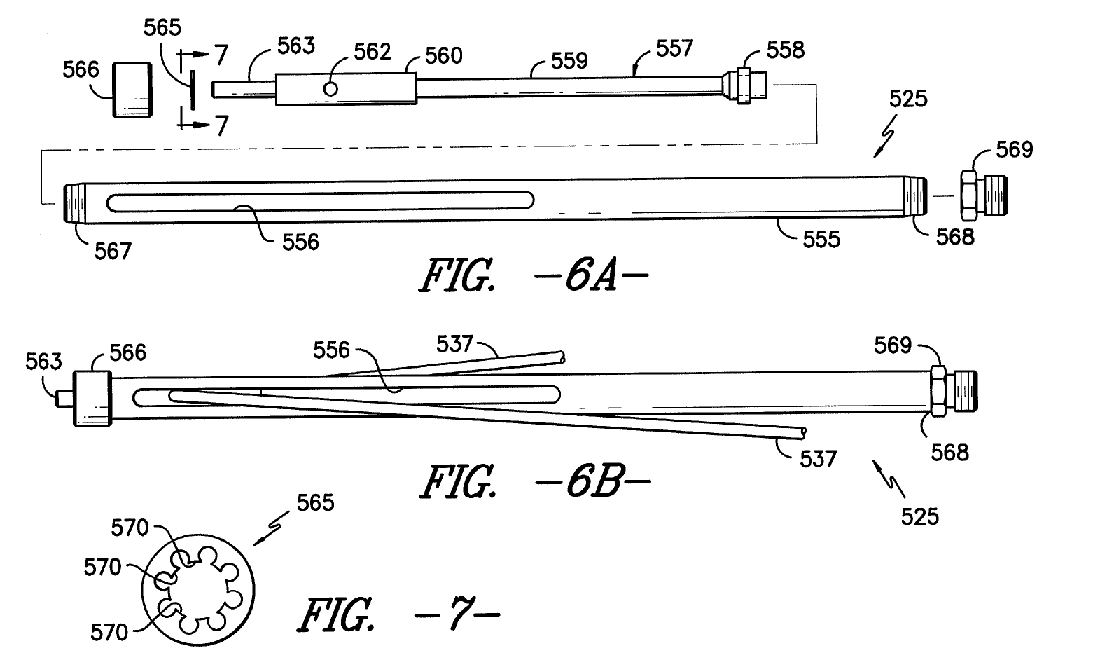

In FIGS. 5A and 5B, there is illustrated a tether tensioning assembly 425 which utilizes inflation gas to dynamically reposition a tensioning tether element 437 while nonetheless being stored at a location remote from the gas generating inflator 426 used to inflate the curtain 410. In this embodiment, the tether tensioning assembly 425 includes a gas accepting cylinder 441 which is attached in fluid communication with the inflatable curtain 410 such that the inflatable curtain 410 is disposed between a gas generating inflator 426 and the gas accepting cylinder 441 of the tether tensioning assembly 425. The gas accepting cylinder 441 is preferably an extension of the gas diffuser normally extending away from the inflatable curtain 410. A gas containment bearing 448 is disposed behind the head portion 443 so as to define a possible length of movement for the piston element 442.

As shown, the tensioning tether element 437 extends through a ring element 449 which rides in attached relation with the piston element 442 at a position behind the gas containment bearing 448. The ring element 449 rides along a path above a channel 450. A plurality of teeth 451 extend away from the side of the channel 450 so as to form projections extending at least partially across the channel 450. During operation, upon inflation of the inflatable curtain 410 a quantity of inflation gas is directed into the gas accepting cylinder 441 thereby depressing the piston element 442 and carrying the tensioning tether element 437 downwardly to the extent permitted by its attachment to the inflating curtain 410.

As illustrated in FIG. 5C, the ring element 449 rides above a spring loaded pin element 452 which is normally biased to a downward position. As movement of the ring element 449 progresses, the spring loaded pin element 452 passes progressively over the projection forming teeth 451 in a ratcheting manner. Upon termination of movement, the spring loaded pin element 452 projects downwardly between adjacent teeth 451 such that the teeth 451 act to block retreat of the piston element 442 back through the gas accepting cylinder 441. The tensioning tether element 437 is thus held in tension both during and after deployment of the inflatable curtain 410.

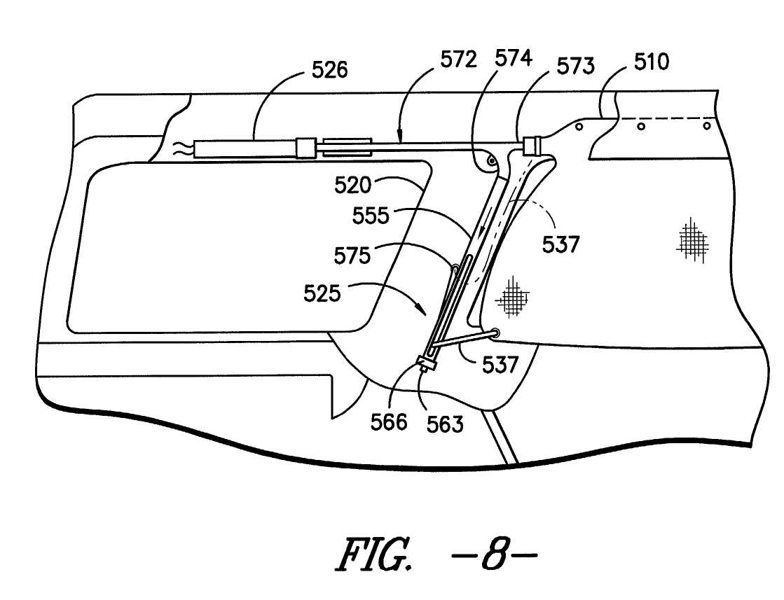

In FIGS. 6A and 6B, there is illustrated a tether tensioning device 525 which may be operated by use of cushion inflating gas to drive a tether conveying piston element. As best illustrated in FIG. 6A, the components of the tether tensioning device 525 include an elongate tubular housing 555 having a pair of diametrically opposed slots 556 having a width sufficient to accept in sliding relation the tensioning tether element 537. Disposed at the interior of the housing 555 is an elongate piston unit 557 which is preferably made of a plastic material. A groove-fitted O-ring 558 is seated around the piston 557 adjacent a proximal end of the piston 557 so as to ensure retention of gas introduced into the housing 555 in a manner as will be described hereinafter. The piston includes a body portion 559 extending to a tether holding portion 560 of enhanced diameter. The tether holding portion 560 includes a tether acceptance opening 562 extending therethrough. The dimensions of the tether acceptance opening 562 are such that the tensioning tether element 537 may be passed in sliding relation through the tether acceptance opening 562. A nipple 563 extends away from the tether holding portion 560. As illustrated, the nipple 563 is preferably tapered to a reduced diameter at its terminal end so as to facilitate sliding insertion into a retaining disk 565 and towards a retaining cap 566.

During assembly, the retaining disk 565 is seated at the interior base of the retaining cap 566. The retaining cap 566 is preferably of an open ended construction so as to establish a passageway through both the retaining disk 565 and the retaining cap 566. The retaining cap with seated retaining disk 565 is thereafter secured over a distal end 567 of the housing 555. The piston 557 may be dropped into the housing 555 through a proximal end 568 and rotated such that the tether acceptance openings 562 are aligned with the slots 556 within the housing 555. If desired, a male connection element 569 may thereafter be threaded over the proximal end 568. The tensioning tether element 537 may thereafter be threaded through the slots 556 and tether acceptance opening 562 for attachment at either end to locations exterior to the tether tensioning device 525.

The tensioning tether element 537 normally supports the light weight piston 557 such that the nipple 563 is held away from the distal end 567 of the housing. However, upon the introduction of a pressurizing medium into the housing through the proximal end 568, the piston 557 is forced to move towards the distal end 567 of the housing such that the nipple 563 penetrates and extends at least partially through the retaining disk 565 and the corresponding retaining cap 566 in the manner as shown in FIG. 6B. Upon the achievement of this position, the piston 557 is thereafter held in place by inwardly extending teeth 570 projecting into the interior of the retaining disk 565. The retaining disk 565 is preferably formed of a spring steel material such that the teeth 570 are of highly resilient character.

To enhance the retention of the nipple within the retaining disk 565, the teeth 570 are preferably angled slightly away from the plane of the perimeter of the disk so as to extend in the direction of movement of the nipple 563. Such an orientation facilitates insertion of the nipple 563 through the interior of the retaining disk 565 while at the same time establishing a locking relationship wherein the resilient teeth 570 tend to bite into the surface of the nipple 563 upon attempted withdrawal.

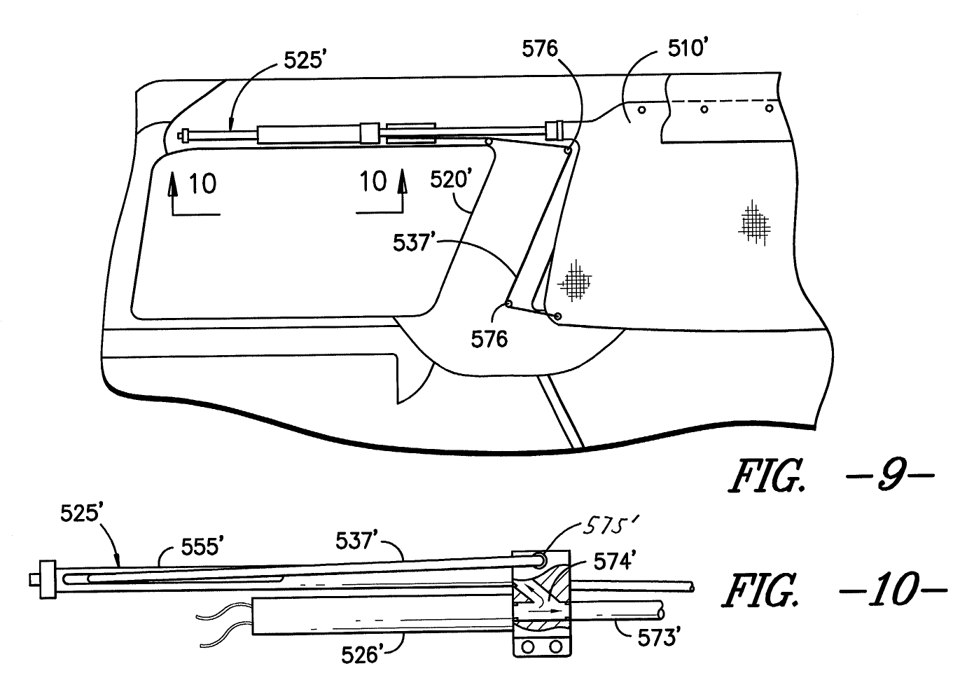

The tether tensioning device 525 as describe in relation to FIGS. 6A and 6B is believed to be useful in a number of applications wherein a common inflator may be used to both pressurize the housing 555 and to simultaneously inflate a cushion operatively connected to one end of the tensioning tether element 537. In FIG. 8, there is illustrated a first exemplary arrangement for a tether tensioning assembly 525 in disposition along an intermediate structural pillar 520 such as a “C” pillar in a vehicle having a four pillar frame structure. In the illustrated arrangement, an inflator 526 is arranged adjacent the roof rail of the vehicle to transmit inflation gas through a gas conduit 572 into the inflatable curtain 510. As shown, the gas conduit 572 is of a branched construction having a first leg 573 which channels gas into the inflatable cushion 510 and a second leg 574 which channels inflation gas into the housing 555 of the tether tensioning device 525.

As shown in broken lines, the tensioning tether element 537 initially extends in looped relation between a lower edge of the stored inflatable curtain 510 through the housing 555 and to a fixed point of attachment 575 along the structural pillar 520. Of course, prior to deployment the tensioning tether element 537 is hidden from view by overlying trim extending in covering relation to the vehicle frame components. As shown in solid lines in FIG. 8, upon activation of the inflator 526 a portion of inflation gas is directed into the housing 555 thereby applying a driving force to the internal piston and biasing the tensioning tether element 537 downward. As with previously described embodiments, this movement of the tensioning tether element establishes an internal tension within the tensioning tether element 537 between the tether tensioning device 525 and the inflatable curtain 510. Thus, a dynamic equilibrium is established during the downward movement of the inflatable cushion 510 until such time as the inflatable curtain 510 is fully deployed and the piston within the housing 555 has been stroked to its full extension and locked in place by engagement between the nipple 563 and the internal retaining disk 565 held at the retaining cap 566. Thereafter, retreat of the tensioning tether element is prevented by the engagement between the nipple 563 and the teeth 570 of the retaining disk 565.

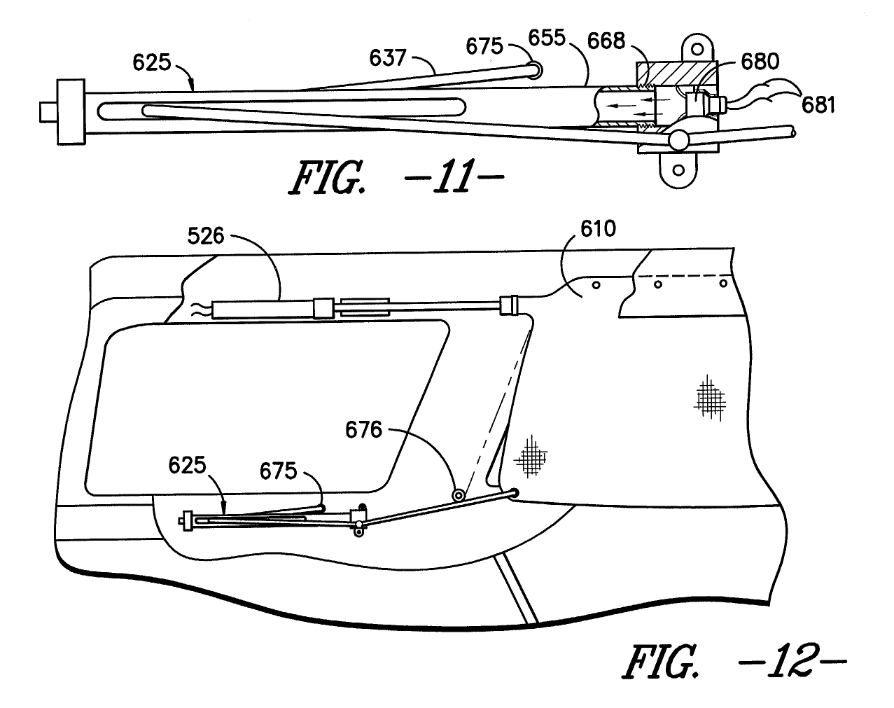

By way of further example, in FIGS. 9 and 10, there is illustrated another arrangement for the inflation gas activated tether tensioning device illustrated and described in relation to FIGS. 6A and 6B. In the arrangement illustrated in FIGS. 9 and 10, components corresponding to those previously illustrated and described are designated by corresponding reference numerals with a prime. In the illustrated arrangement, a tether tensioning device 525′ is housed along the roof rail of the vehicle adjacent to a gas generating inflator 526′. As shown in the break-out section of FIG. 10, the inflator directs inflation gas along a first leg 573′ but also diverts a portion of gas back through a second leg 574′ and into the housing 555′. As illustrated in broken lines, prior to activation, the tensioning tether element 537′ extends away from the inflatable curtain 510′, around a series of guide pulleys 576′ arranged at the structural pillar 520′ and through the tether tensioning device 525′ to a point of attachment 575′. In this arrangement, as the air bag cushion 510′ is deployed downwardly away from the roof rail the pressure from the inflation gas which enters the housing 555′ causes the slack which would otherwise occur in the tensioning tether element 537′ to be taken up by movement of the interior piston thereby pulling the tensioning tether 537′ around the guide pulleys and maintaining the tensioning tether element in a substantially taut state during and after deployment of the inflatable curtain 510′.

It is contemplated that the arrangement of elements as illustrated and described in relation to FIGS. 6A and 6B may also be used in conjunction with a dedicated initiating device such as a gas generating squib element or micro-gas generator which releases a relatively small quantity of pressurized gas on demand so as to drive the tether holding piston from a first position to a second position at a given time without reliance upon gas produced by the inflator for the cushion. Of course other members such as a small servomotor or the like may also be utilized to move the piston.

One illustrative arrangement for a self-actuating tether tensioning device 625 is illustrated in FIG. 11. As shown, this assembly is substantially identical to that as illustrated and described in relation to FIGS. 6A and 6B with the exception that a selectively activatable micro-gas generator or squib 680 is affixed at the proximal end 668 of the housing 655. As will be appreciated, the micro-gas generator 680 is simply a small inflator which may be selectively activated upon the receipt of an activating signal through leads 681. Upon activation, a pulse of pressurized gas is developed thereby causing the sliding relocation of the piston within the housing 655 in the manner as previously described.

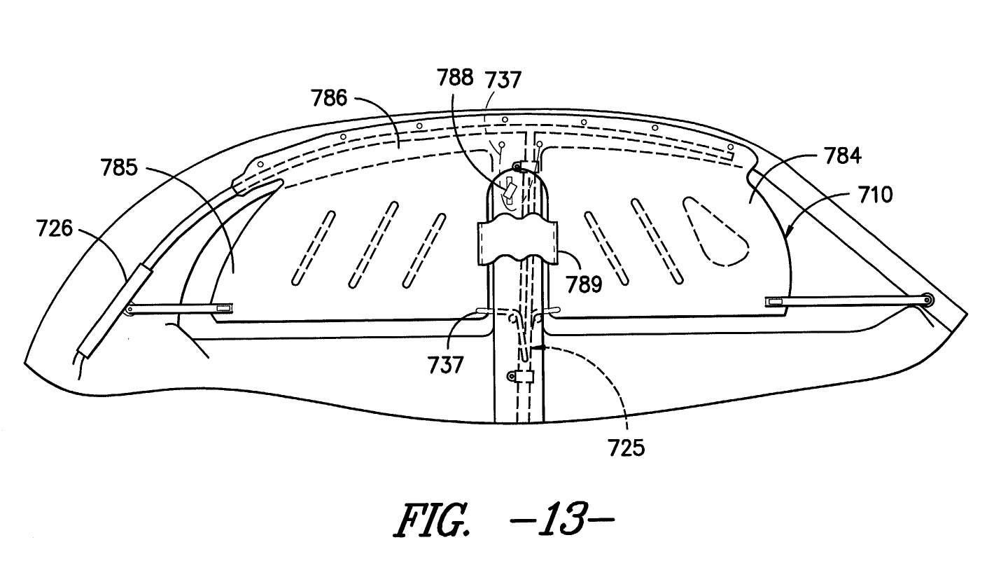

One possible arrangement for the tether tensioning device 625 within a vehicle is illustrated in FIG. 12. As shown in dotted lines, in this arrangement the tensioning tether element 637 extends directly from a lower portion of the inflatable curtain 610 to the tether tensioning device 625 along a guide path defined by a properly placed guide pulley element 676. Upon activation of the curtain inflator 626, the lower portion of the inflatable curtain 610 expands downwardly away from roof rail and across a side portion of the vehicle interior. At a desired time relative to the activation of the cushion inflator 626, the micro-gas generator 680 may also be activated thereby applying a biasing tension to the tensioning tether element 637. It is contemplated that the activation of the micro-gas generator 680 may substantially coincide with the activation of the curtain inflator 626. However, it is also contemplated that such activation may take place either before or after the activation of the curtain inflator 626 as may be desired to achieve a given tensioning effect.

As will be appreciated, the ability to selectively activate the tether tensioning assembly 625 may be beneficial in permitting a wider range of placement options for the tether tensioning assembly 625 within the vehicle since gas communication with the curtain inflator 626 is no longer required. In addition, it is contemplated that the ability to selectively actuate the tether tensioning assembly 625 may provide enhanced operational benefits by permitting tensioning to be adjusted based upon the actual conditions occurring during a collision event.

It is contemplated the elongate tether tensioning assembly geometry of the configurations as illustrated in FIGS. 6A, 6B and 11 may be particularly useful in the development and retention of tension between adjacent portions of a split cushion geometry such as may be used to effect deployment around seat belt structures. One such arrangement is illustrated in FIG. 13. As shown, the inflatable curtain 710 in FIG. 13 is of a split construction having a forward section 784 and a rear section 785 in fluid communication with one another along a common inflated header 786. The forward section 784 is arranged to cover a region between the “A” pillar and the intermediate “B” pillar, while the rear section 785 is arranged to cover a region between the intermediate “B” pillar and the rearward “C” pillar.

In the illustrated arrangement, the forward section 784 and the rear section 785 are separated by a gap disposed in overlying relation to a portion of the “B” pillar so as to avoid interference between the inflated curtain 710 and a seat belt web guide ring 788 located at the “B” pillar. If desired, an optional bridging element 789 such as a piece of fabric or the like may extend between the forward and rearward sections. As shown in broken lines, prior to deployment a tensioning tether element 737 extends in hanging relation between opposing edges of the forward and rearward sections. As illustrated, the orientation of the tensioning tether element 737 is such that it hangs below the seat belt web guide ring 788 and is hidden by the overlying trim. Upon activation of the curtain inflator 726, the tensioning tether element is pulled downwardly with the curtain 710. Simultaneously, any relaxation within the tensioning tether element 737 is taken up by the tether tensioning device 725 such that the tensioning tether element 737 pulls the attached portions of the inflatable curtain 710 inwardly towards the tether tensioning device 725 in the manner shown.

In the illustrated embodiment, the tether tensioning device 725 is operated by fluid communication with the cushion inflator 726. However, it is to be appreciated that the tether tensioning device 725 may also utilize a microgas generator if desired. It is to be understood that in actual practice, the length of the tether tensioning device 725 may be required to be fairly extensive so as to extend a substantial distance below the region to be covered by the inflatable curtain 710. However, it is believed that the requisite distance is generally readily available.

It is to be understood that while the present invention has been illustrated and described in relation to certain potentially preferred embodiments, constructions and procedures the presentation of such embodiments, constructions and procedures is intended to be illustrative only and the present invention is in no event to be limited thereto. Accordingly, it is to be understood that the present invention is intended to extend to all modifications and variations as may incorporate the broad aspects of the invention which fall within the full spirit and scope of the appended claims and all equivalents thereto.

1. A tensioning assembly for applying tension across an inflatable curtain air bag within a transportation vehicle during downward deployment of the inflatable curtain air bag from an elevated storage position in covering relation to portions of the vehicle below said elevated storage position, the tensioning assembly comprising:
at least one elongate tether element operatively connected to the inflatable curtain air bag, the tether element including a tethering segment extending away from the inflatable curtain air bag; and
a dynamic tensioning device operatively connected to said tethering segment at a location removed from the inflatable curtain air bag, the dynamic tensioning device comprising a displaceable sliding carrier engaging said tethering segment such that upon displacement of the sliding carrier, a portion of the tethering segment is displaced in a substantially downward direction relative to the elevated storage position of the inflatable curtain air bag.

2. A tensioning assembly as recited in claim 1, wherein the sliding carrier comprises a gas transmitting cylinder defining a gas transmission path between a gas generating inflator and a gas inlet opening within the inflatable curtain air bag such that upon the development of inflation pressure within the inflatable curtain air bag, the gas transmitting cylinder is biased away from the gas inlet opening.

3. A tensioning assembly as recited in claim 2, wherein the gas transmitting cylinder is substantially straight.

4. A tensioning assembly as recited in claim 3, wherein the gas transmitting cylinder slides along a path angled away from the portions of the vehicle covered by the inflatable curtain air bag such that progressive movement along said path increases horizontal tension within the inflatable curtain air bag.

5. A tensioning assembly as recited in claim 2, wherein the gas transmitting cylinder is substantially “U” shaped.

6. A tensioning assembly as recited in claim 3, wherein the gas transmitting cylinder slides along a path angled away from the portions of the vehicle covered by the inflatable curtain air bag such that progressive movement along said path increases horizontal tension within the inflatable curtain air bag.

7. A tensioning assembly as recited in claim 1, wherein the sliding carrier comprises a displaceable piston element moveable in response to pressure from gas emitted from a gas generating inflator.

8. A tensioning assembly as recited in claim 7, wherein the gas generating inflator is in common fluid communication with both the displaceable piston element and with the inflatable curtain air bag such that the gas generating inflator defines a common source of gas for inflating the inflatable curtain air bag and for moving the displaceable piston element.

9. A tensioning assembly as recited in claim 8, wherein the displaceable piston element is disposed upstream of the inflatable curtain air bag.

10. A tensioning assembly as recited in claim 8, wherein the displaceable piston element is disposed downstream of the inflatable curtain air bag.

11. A tensioning assembly as recited in claim 8, wherein the displaceable piston element is operable in conjunction with a locking element to obstruct retreat of the displaceable piston element following pressure activated movement.

12. A tensioning assembly for applying tension across an inflatable curtain air bag within a transportation vehicle during downward deployment of the inflatable curtain air bag from an elevated storage position in covering relation to portions of the vehicle below said elevated storage position, the tensioning assembly comprising:
at least one elongate tether element operatively connected to the inflatable curtain air bag, the tether element including a tethering segment having a distal end extending away from the inflatable curtain air bag, the distal end being held in place at a tether attachment location outboard of the inflatable curtain air bag; and
a dynamic tensioning device including a housing and a force activated displaceable carrier disposed within the housing, the displaceable carrier being adapted to slidingly engage the tethering segment at a location along the tethering segment between the tether attachment location and the inflatable curtain air bag such that upon movement of the displaceable carrier, a portion of the tethering segment is movable in self adjusting sliding relation relative to the displaceable carrier whereby the tethering segment is maintained in a state of balanced tension across the displaceable carrier between the inflatable curtain air bag and the tether attachment location during downward deployment of the inflatable curtain air bag.

13. A tensioning assembly as recited in claim 12, wherein the displaceable carrier comprises an elongate piston element.

14. A tensioning assembly as recited in claim 13, wherein the elongate piston element is moveable in response to pressure from a gas entering the housing.

15. A tensioning assembly as recited in claim 14, wherein a common a gas generating inflator provides inflation gas for inflating the inflatable curtain air bag and for moving the elongate piston element within the housing.

16. A tensioning assembly as recited in claim 14, wherein a discrete gas generating element is disposed in fluid communication with the housing.

17. A tensioning assembly as recited in claim 16, wherein the discrete gas generating element is selectively activatable substantially independent of inflation of the inflatable curtain air bag.

18. A tensioning assembly as recited in claim 12, wherein the dynamic tensioning device further includes a retaining element adapted to engage and hold the displaceable carrier in place following pressure activated movement of the displaceable carrier.

19. A tensioning assembly as recited in claim 18, wherein the displaceable carrier comprises an elongate piston element of plastic material including a nipple portion projecting in the direction of movement of the displaceable carrier and wherein the retaining element comprises an annular disk having an interior opening adapted to accept the nipple portion of the elongate piston element therethrough, the annular disk including a plurality of inwardly projecting resilient teeth extending into the interior opening such that said resilient teeth are displaced in spreading relation around the nipple portion upon insertion through the interior opening.

20. A tensioning assembly as recited in claim 19, wherein the inwardly projecting resilient teeth include terminal ends angled away from the plane of the annular disk in the direction of movement of the nipple portion such that upon insertion of the nipple portion, the resilient teeth are pushed outwardly in surrounding relation to the nipple portion and such that upon attempted withdrawal of the nipple portion, the resilient teeth bite into the surface of the nipple portion whereby withdrawal is prevented.

21. A tensioning assembly as recited in claim 19, wherein the annular disk is disposed in seated relation at the interior of an end cap structure disposed at an end portion of the housing.

22. A tensioning assembly for applying tension across an inflatable curtain air bag within a transportation vehicle during downward deployment of the inflatable curtain air bag from an elevated storage position in covering relation to portions of the vehicle below said elevated storage position, the tensioning assembly comprising:
at least one elongate tether element operatively connected to the inflatable curtain air bag, the tether element including a tethering segment having a distal end extending away from the inflatable curtain air bag, the distal end being held in place at a tether attachment location outboard of the inflatable curtain air bag; and
a dynamic tensioning device including an elongate housing having at least one pair of substantially opposing elongate slots and a force activated displaceable piston element disposed within the housing, the displaceable piston element moveable in response to pressure from a gas entering the housing, the displaceable piston element including a tether acceptance opening extending therethrough adapted to slidingly engage the tethering segment at a location along the tethering segment between the tether attachment location and the inflatable curtain air bag such that upon movement of the displaceable piston element, a portion of the tethering segment is movable in self adjusting sliding relation through the displaceable piston element whereby the tethering segment is maintained in a state of balanced tension across the displaceable piston element between the inflatable curtain air bag and the tether attachment location during downward deployment of the inflatable curtain air bag.

23. A tensioning assembly as recited in claim 22, wherein a common a gas generating inflator provides inflation gas for inflating the inflatable curtain air bag and for moving the displaceable piston element within the housing.

24. A tensioning assembly as recited in claim 22, wherein a discrete gas generating element is disposed in fluid communication with the housing.

25. A tensioning assembly as recited in claim 24, wherein the discrete gas generating element is selectively activatable substantially independent of inflation of the inflatable curtain air bag.

26. A tensioning assembly as recited in claim 22, wherein the dynamic tensioning device further includes a retaining element adapted to engage and hold the displaceable piston element in place following pressure activated movement of the displaceable piston element.

27. A tensioning assembly as recited in claim 26, wherein the displaceable piston element comprises a plastic structure including a nipple portion projecting in the direction of movement of the displaceable piston element and wherein the retaining element comprises an annular disk of spring steel having an interior opening adapted to accept the nipple portion of the piston element therethrough, the annular disk including a plurality of integral inwardly projecting resilient teeth extending into the interior opening such that said resilient teeth are displaced in spreading relation around the nipple upon insertion through the interior opening and bite into the nipple upon attempted withdrawal of the nipple through the interior opening.

28. A tensioning assembly for applying tension across a gap within a segmented inflatable curtain air bag of split construction during downward deployment of the inflatable curtain air bag from an elevated storage position within a transportation vehicle over portions of the vehicle below said elevated storage position such that a first portion of the inflatable curtain air bag is disposed on one side of a seat belt web guide ring disposed at a structural pillar of the vehicle and a second portion of the inflatable curtain air bag is disposed on an opposing side of the seat belt web guide ring, the tensioning assembly comprising:
at least one elongate tethering element disposed between the first and second portions of the inflatable curtain air bag; and
a dynamic tensioning device including a housing and a force activated displaceable carrier disposed within the housing, the displaceable carrier being adapted to slidingly engage the tethering element between the first and second portions of the inflatable curtain air bag at a position below the seat belt web guide ring such that upon downward movement of the displaceable carrier, the tethering element is movable downwardly away from the seat belt web guide ring in tensioned relation to the displaceable carrier and such that the tethering element is held in self adjusting sliding relation relative to the displaceable carrier whereby the tethering element is maintained in a state of tension between the displaceable carrier and each of the first and second portions of the inflatable curtain air bag.
